(19) United States
(12) Patent Application Publication
(10) Pub. No.: US 2021/0284101 A1
(43) Pub. Date: Sep. 16, 2021

(54) CLEANING DEVICE INTENDED FOR SPRAYING AT LEAST ONE FLUID ONTO A SURFACE TO BE CLEANED OF A MOTOR VEHICLE

(71) Applicant: Valeo Systèmes d'Essuyage, Le Mesnil Saint Denis (FR)

(72) Inventors: Giuseppe Grasso, Issoire (FR); Grégory Kolanowski, Issoire (FR); Marcel Trebouet, Le Mesnil Saint Denis (FR)

(73) Assignee: Valeo Systèmes d'Essuyage, Le Mesnil Saint Denis (FR)

(21) Appl. No.: 16/336,702

(22) PCT Filed: Aug. 3, 2017
(86) PCT No.: PCT/EP2017/069634

§ 371 Date: Mar. 26, 2019

(30) Foreign Application Priority Data
Sep. 28, 2016 (FR) 1659179

(51) Int. Cl. B60S 1/52; B60S 1/54; B60S 1/56

(52) U.S. Cl. CPC B60S 1/528; B60S 1/56; B60S 1/54

(57) ABSTRACT

The cleaning device according to the invention comprises at least one fluid inlet and distribution device (D) into which a cleaning fluid and a drying fluid are selectively injected from an inlet nozzle (110, 111) specific to each fluid. Said inlet and distribution device (D) includes separate distribution channels (21, 22) for distributing the cleaning fluid and the drying fluid, respectively, and separate conveying units (112, 114, 21; 113, 22) for conveying each of the fluids from the respective inlet nozzle thereof (110, 111) to the respective distribution channel thereof (21, 22).

The present invention relates to the field of driving assistance devices and, more particularly, to the field of optical detection systems used to this end. The invention relates more particularly to cleaning devices intended for spraying at least one fluid onto a surface to be cleaned of a motor vehicle, such as an optical sensor or an optical detection system.

The term optical detection system is used to denote any system including optical sensors, such as cameras, laser sensors (commonly known as LIDAR) or other sensors based on the emission and/or detection of light in the spectrum visible or invisible to humans, particularly infrared.

Such optical detection systems are provided on an ever-increasing number of motor vehicles in order to assist the driver of the vehicle in certain driving situations, a well-known example of which is parking assistance. For this assistance to be as effective as possible, the data supplied by the optical detection system must be of the best possible quality, and it is therefore essential to have clean optics to perform these data acquisitions. To do this, a device for cleaning a sensor of the optical detection system (for example the lens of a still camera) can be controlled to inject a cleaning fluid onto said sensor just before the detection (for example the exposure) is performed. These cleaning devices must not hinder the operation of the optical sensor, and they must be as compact as possible to meet the space constraints of the vehicle. In addition, as the cleaning fluid sprayed onto such an optical sensor to remove the dirt from it is usually a liquid, it is beneficial to dry this optical sensor as quickly as possible in order to avoid any risk of contamination of the signal with any marks that such a liquid might leave (specks, runs, etc.). For this, it is known to spray onto the optical sensor, after the cleaning fluid, a stream of air (or another drying fluid) that makes it possible to rid this sensor of the cleaning fluid and the dirt that it then carries with it. Such cleaning devices therefore include means for transporting and distributing the cleaning fluid and the drying fluid. Usually, the cleaning fluid distribution circuit and the drying fluid (usually air) distribution circuit include shared portions and/or are nested with one another. In particular, it is known to distribute the cleaning fluid and the drying fluid onto the surface of the optical sensor through a single distribution unit, which is usually in the form of a distribution nozzle supplied by a distribution channel in which the cleaning fluid and the drying fluid are alternately carried. This distribution channel conventionally opens out, at the extremity of the distribution nozzle, into one or more distribution orifices configured so that the cleaning fluid and the drying fluid reach as much of the surface of this sensor as possible. Although such an arrangement offers advantages in terms of the space required, it does however present a risk of mixing the fluids. In particular, immediately before the distribution of the drying fluid, a varying residual quantity of cleaning fluid might remain trapped in the distribution channel, and then be delivered onto the surface of the optical sensor at the same time as the drying fluid. This results in imperfect drying of the optical sensor that is detrimental to the satisfactory operation thereof.

The object of the present invention is to improve the effectiveness of such cleaning devices, while avoiding any mixing of the cleaning and drying fluids.

To this end, the invention relates to a cleaning device, intended for spraying at least one fluid onto a surface to be cleaned of a motor vehicle, such as an optical sensor of an optical detection system, comprising at least one fluid inlet and distribution device into which a cleaning fluid and a drying fluid are selectively injected from an inlet nozzle specific to each fluid. The inlet and distribution device includes separate distribution channels for distributing the cleaning fluid and the drying fluid respectively, particularly towards the surface to be cleaned, and separate conveying units for conveying each of the fluids from the respective inlet nozzle thereof to the respective distribution channel thereof.

Surface to be cleaned is given to mean an optical sensor of an optical detection system, the lens of a camera, or a particular element of the body.

According to one feature of the invention, the separate distribution channels for distributing the cleaning fluid and the drying fluid respectively include distribution orifices specific to each channel.

The separate distribution channels can be made in an inlet and distribution rod arranged in a hollow body of the inlet and distribution head.

The hollow body can have a substantially cylindrical shape, and can be made in two parts connected to each other by a locking ring. Provision can be made for the hollow body to consist of an upstream part, formed from a peripheral wall and an upstream end, a downstream part, formed from a peripheral wall and a downstream end, and a locking ring that provides the connection between the upstream part and the downstream part. The peripheral wall of the upstream part of the hollow body and the peripheral wall of the downstream part of the hollow body can then both have a substantially cylindrical shape and have substantially identical inner and outer diameters and axial dimensions. It must be understood here, and hereinafter, that the designations “upstream” and “downstream” refer to the direction of flow of the cleaning and drying fluids in the inlet and distribution head of the cleaning device according to the invention. Thus, the designation “upstream” refers to the side of the head through which these cleaning and drying fluids are injected into it, and the designation “downstream” refers to the side of the head through which the cleaning and drying fluids are distributed out of it, onto the surface of the optical sensor in question.

The locking ring can be configured to receive in support the peripheral walls of the upstream and downstream parts of the hollow body, and it includes first and second sleeves forming means for guiding the upstream and downstream parts of the hollow body during the assembly thereof. During the assembly of the hollow body, the upstream part and the downstream part thereof are thus fitted onto the first sleeve and the second sleeve respectively. The upstream part, the downstream part and the locking ring of the hollow body thus define a cavity that forms the inside of the hollow body. The device can include means for sealing this cavity vis-à-vis the outside of the device according to the invention, which in particular take the form of two O-rings each inserted in a groove arranged to this end on the periphery of the inner wall of the upstream end and on the periphery of the inner wall of the downstream end.

The upstream end shuts off the cavity of the hollow body upstream, substantially perpendicularly to the peripheral wall of the upstream part thereof. A cleaning fluid inlet nozzle and a drying fluid inlet nozzle, separate from each other, extend in an upstream direction from the upstream end. It will be understood that the nozzles could be made differently and not both connected to the upstream end, provided that they permit the performance of the functions described below.

Each of these inlet nozzles can have a substantially cylindrical shape and be pierced right through, from upstream to downstream in the direction of the axis of rotation thereof, by an inlet channel for injecting the corresponding fluid: the cleaning fluid inlet nozzle is thus pierced by a cleaning fluid inlet channel, and the drying fluid inlet nozzle is pierced by an inlet channel for injecting this drying fluid.

According to one feature of the invention, one inlet nozzle opens out into a cavity formed in the hollow body and in which the rod is housed, the other inlet nozzle opening out directly into a conveying tube housed in a corresponding inlet channel formed in the rod.

The cleaning fluid inlet nozzle is pierced right through, from upstream to downstream, by a cleaning fluid inlet channel that opens out into the cavity, and particularly flush with the upstream end.

The drying fluid inlet nozzle is continued by a conveying tube the downstream extremity of which extends in a drying fluid distribution channel made in the rod, said drying fluid inlet nozzle and said tube being pierced right through, from upstream to downstream, by an inlet channel for injecting this drying fluid that opens out into the drying fluid distribution channel in the rod.

According to a series of features, taken alone or arrangement in which the rod is movable in the hollow body, provision can be made for:
the cleaning device to include means for moving the inlet and distribution rod between an idle position and an extended position inside the hollow body;
the means for moving the inlet and distribution rod to comprise means shared with conveying units for conveying one of the fluids, and particularly the cleaning fluid conveying unit;
the arrival of fluid through the inlet nozzle opening out into the cavity to contribute to the filling of this cavity and the movement of the rod;
the means for moving the inlet and distribution rod to comprise an element for the elastic return to position of the rod;
the drying fluid distribution channel to have a substantially constant diameter at least in the portion in which the conveying tube is caused to move;
a peripheral groove to be arranged in the outer wall of the conveying tube to receive a seal configured to rub against the drying fluid distribution channel in which the conveying tube is housed;
from the upstream extremity of the distribution rod to the downstream extremity thereof, the drying fluid distribution channel to have at least one upstream portion and one downstream portion the diameter of which is smaller than the diameter of the upstream portion;
the diameter of the drying fluid distribution channel, the outer diameter of the conveying tube and the dimensions of the O-ring arranged in the vicinity of the downstream extremity of said conveying tube to be defined so that the conveying tube can slide in a sealed manner within the upstream portion of the drying fluid distribution channel.

According to one feature of the invention, a finger extends inside the cleaning fluid distribution channel, the finger being offset relative to the axis of elongation of the cleaning fluid inlet nozzle. This finger can in particular be arranged, transversely to the direction of elongation of the device, between the inlet nozzle and the conveying tube, and it can have a substantially cylindrical shape.

The cleaning fluid distribution channel and the drying fluid distribution channel can be arranged, within the distribution rod, such that the conveying tube and the finger of this same hollow body can simultaneously be engaged in the drying fluid distribution channel and in the cleaning fluid distribution channel respectively during the assembly of the inlet and distribution head.

Advantageously, the cleaning fluid inlet nozzle, the drying fluid inlet nozzle, the conveying tube, the cleaning fluid and drying fluid inlet channels and this finger are all parallel to each other.

According to one feature of the invention, the cleaning fluid distribution channel has portions with different diameters, these diameters decreasing from the upstream extremity of the distribution rod to the downstream extremity thereof, at least the downstream extremity of the finger being configured to extend in portions with different diameters depending on the relative movement of the finger in relation to the rod.

Thus, from the upstream extremity of the distribution rod to the downstream extremity thereof, the cleaning fluid distribution channel includes at least one upstream portion, one intermediate portion, the diameter of which is slightly smaller than the diameter of the upstream portion, and a downstream portion, the diameter of which is smaller than the diameter of the intermediate portion. The diameter of the intermediate portion of the cleaning fluid distribution channel, the outer diameter of the finger of the hollow body, and the dimensions of the O-ring arranged in the vicinity of the downstream extremity of this finger are defined so that said finger can slide in a sealed manner within said intermediate portion of the cleaning fluid distribution channel.

According to additional features of the invention, provision can be made for the downstream end of the hollow body to be pierced with an orifice the walls of which continue both upstream, within the cavity of the hollow body, and downstream, outside the hollow body, by means of a sleeve the features and dimensions of which will be detailed below.

According to different features, taken alone or in combination with other features mentioned above or below respectively, provision can be made for:
the diameter of the intermediate portion of the cleaning fluid distribution channel, the outer diameter of the finger of the hollow body, and the dimensions of the O-ring arranged in the vicinity of the downstream extremity of this finger to be defined so that the finger can slide in a sealed manner within the intermediate portion of the cleaning fluid distribution channel and let the cleaning fluid through when the seal is within the upstream portion;
the distribution rod to include, in the vicinity of the upstream extremity thereof, a rim;
the elastic return element to press against a surface of the rim;
a peripheral groove to be arranged in the outer wall of the rim, to receive a seal, such that the distribution rod, provided with said seal, can slide in a sealed manner within the hollow body.

Advantageously, the cleaning fluid distribution channel and the drying fluid distribution channel are transversely arranged, within the distribution rod, with spacing substantially identical to the spacing between the finger of the hollow body and the conveying tube that continues the drying fluid inlet nozzle within the hollow body. In other words, the hollow body and the rod of the device according to the invention are respectively configured so that this conveying tube and the finger of this same hollow body can simultaneously be engaged in the drying fluid distribution channel and in the cleaning fluid distribution channel respectively.

According to one feature of the invention, the cleaning device can comprise, in addition to the inlet and distribution head containing the separate distribution channels, a cleaning fluid storage tank, a drying fluid storage tank, and elements for governing the circulation of cleaning fluid between the tank and the head. These governing elements, which can take the form of a distributor governed by a control module, are configured to adopt several positions in which:
it is possible to block the injection of cleaning fluid into the inlet and distribution head in an idle position;
it is possible to supply the head with cleaning fluid in order firstly to move the head into a cleaning position and secondly to spray cleaning fluid; and
it is possible to block the cleaning fluid in the cavity and keep the head in the cleaning position, the supply of drying fluid being capable of being governed independently of the supply of cleaning fluid.

The invention also relates to an optical detection system for a motor vehicle, characterized in that it includes a cleaning device as described above, particularly for cleaning an optical sensor, and a motor vehicle provided with an optical detection system, characterized in that it includes at least one cleaning device intended for spraying at least one fluid onto an optical sensor of this optical detection system.

Further features, details and advantages of the invention and the operation thereof will become apparent on reading the following description, given as an illustration, with reference to the attached figures, in which:

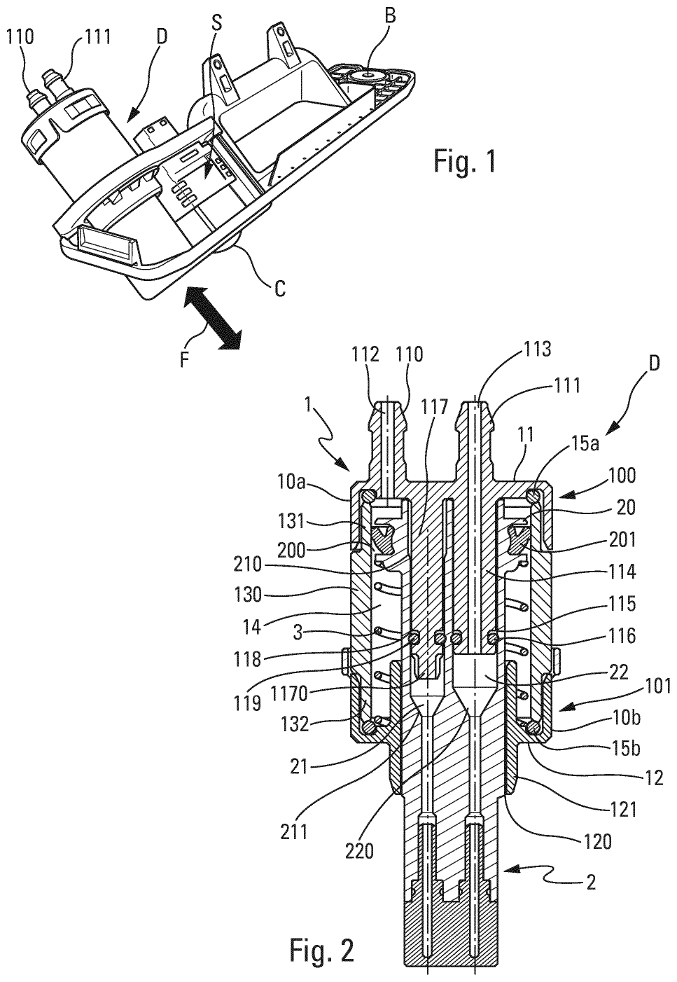

FIG. 1 is a diagrammatic perspective view of a sensor of an optical detection system and an associated cleaning device,

FIG. 2 is a diagrammatic cross-sectional view of the inlet and distribution head of a cleaning device according to the invention, in the idle position thereof as described above,

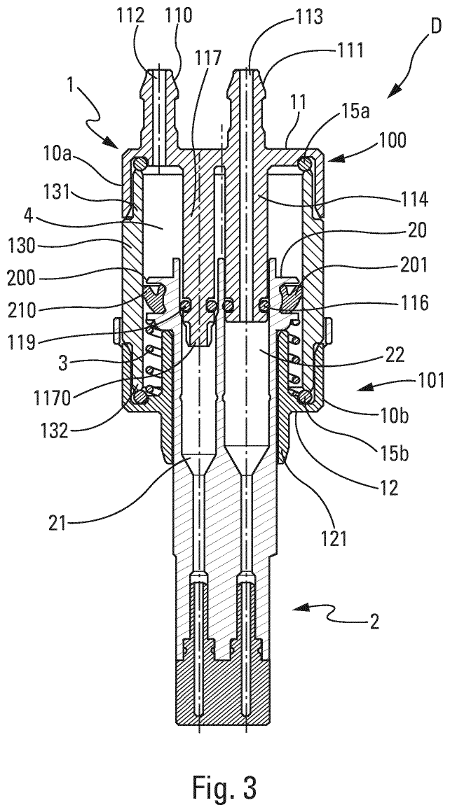

FIG. 3 is a diagrammatic cross-sectional view of the inlet and distribution head of a cleaning device according to the invention, in the cleaning position thereof as described above,

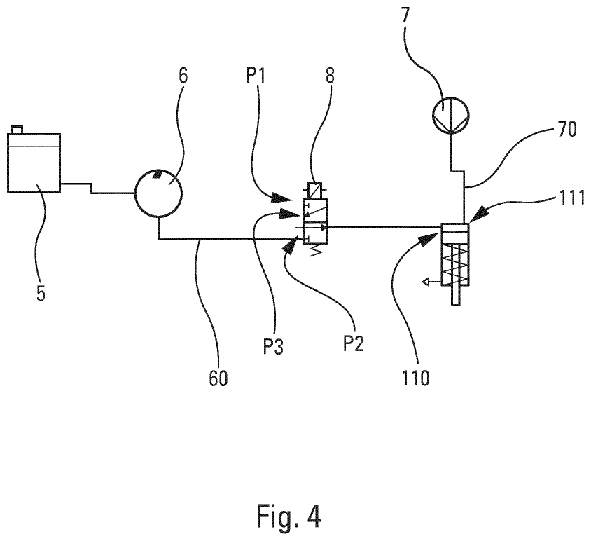

and FIG. 4 is a diagrammatic general view of the hydraulic architecture of a cleaning device according to the invention.

Firstly, it must be noted that although the figures disclose the invention in detail for the implementation thereof, they can of course serve to better define the invention if necessary.

It must also be remembered that, in the description below, the designations “upstream” and “downstream” refer to the direction of flow of the cleaning and drying fluids in the cleaning device according to the invention. Thus, the designation “upstream” refers to the side of the device according to the invention through which these cleaning and drying fluids are injected into it, and the designation “downstream” refers to the side of the device according to the invention through which the cleaning and drying fluids are distributed out of it, onto a surface of an optical sensor of an optical detection system of a motor vehicle.

FIG. 1 shows a cleaning device according to the invention, i.e. a device for cleaning an optical sensor C, forming part of an optical detection system S for a motor vehicle, the cleaning device comprising at least one fluid inlet and distribution device D into which a cleaning fluid and a drying fluid are selectively injected through two separate conveying units from an inlet nozzle 110, 111 specific to each fluid. The fluid inlet and distribution device D is mobile in translation in the direction shown by the arrow F, between an extended position in which distribution orifices are arranged facing the optical sensor, and a retracted position (shown in FIG. 1) in which the fluid inlet and distribution device is retracted inside a body structure housing B of the vehicle both to protect it and in order not to hinder the optical detection of the sensor.

With reference to FIGS. 2 and 3, an inlet and distribution head of a cleaning device according to the invention includes at least one hollow body 1 for injecting a cleaning fluid and a drying fluid respectively, a rod 2 for distributing these fluids, and a spring-type elastic return element 3. The rod is caused to slide inside the hollow body, translated between two extreme positions due to the elastic return force of the spring and the pressure of a fluid used for cleaning and/or drying and passing through the hollow body before exiting the inlet and distribution head.

In the example shown in FIGS. 2 and 3, the hollow body 1 has a substantially cylindrical general shape, and includes two parts connected to each other by a locking ring. More specifically, the hollow body 1 consists of an upstream part 100, formed from a peripheral wall 10a and an upstream end 11, a downstream part 101, formed from a peripheral wall 10b and a downstream end 12, and a locking ring that provides the connection between the upstream part 100 and the downstream part 101. The peripheral wall 10a of the upstream part 100 of the hollow body 1 and the peripheral wall 10b of the downstream part 101 of the hollow body 1 both have a substantially cylindrical shape and have substantially identical inner and outer diameters and axial dimensions.

According to the embodiment of the invention more particularly shown in FIGS. 2 and 3, the locking ring has a substantially cylindrical shape and includes, along the direction of the axis of rotation thereof, a central part 130 that is continued, upstream, by a first sleeve 131 with the same inner diameter as the central part 130 and a slightly smaller outer diameter than the outer diameter of the central part, and, downstream, by a second sleeve 132, with the same inner diameter as the central part 130 and a slightly smaller outer diameter than the outer diameter of the central part. The outer diameter of the central part 130 of the locking ring is substantially equal to the outer diameter of the peripheral walls, 10a and 10b respectively, of the upstream and downstream parts, 100 and 101 respectively, of the hollow body 1. Similarly, the outer diameters of the first and second sleeves 131 and 132 are identical, and they are very slightly smaller than the inner diameters of the peripheral walls, 10a and 10b respectively, of the upstream and downstream parts, 100 and 101 respectively, of the hollow body 1. Axially, the respective dimensions of the first sleeve 131 and the second sleeve 132 of the locking ring are substantially equal to the inner axial dimensions of the peripheral walls, 10a and 10b respectively, of the upstream and downstream parts of the hollow body 1. Thus, the shoulders formed at the intersection of the outer wall of the central part 130 of the locking ring and the outer walls of the first and second sleeves, 131 and 132 respectively, of this same locking ring, form, during assembly of the hollow body, bearing faces for the peripheral walls, 10a and 10b respectively, of the upstream and downstream parts of the hollow body 1. During the assembly of the hollow body 1, the upstream part and the downstream part thereof are thus fitted onto the first and second sleeves 131, 132 respectively, which then produce a shape for guiding the peripheral walls of the upstream and downstream parts of the hollow body 1 into this fitting.

The upstream part 100, the downstream part 101 and the locking ring of the hollow body 1 thus define a cavity 14 that forms the inside of the hollow body 1. Means for sealing the cavity 14 vis-à-vis the outside of the device according to the invention can be inserted between the locking ring and the upstream part 100 and the downstream part 101 of the hollow body 1 respectively, and these sealing means can in particular take the form of two O-rings, 15a and 15b respectively, each inserted into a groove arranged to this end on the periphery of the inner surface of the upstream end 11 and on the periphery of the inner surface of the downstream end 12 respectively.

During the assembly of the hollow body 1, the extremity of the first sleeve 131 and the extremity of the second sleeve 132 of the locking ring press against these O-rings, thus closing the cavity 14 of the hollow body in a sealed manner. This closure can be enhanced by additional means of locking the locking ring to the upstream and downstream parts of the hollow body, for example screws, not shown in FIGS. 2 and 3, and inserted radially between the peripheral wall 10a of the upstream part of the hollow body and the first sleeve 131 of the locking ring and/or between the peripheral wall 10b of the downstream part of the hollow body and the second sleeve 132 of the locking ring.

The upstream end 11 shuts off the cavity 14 and the hollow body 1 upstream, substantially perpendicularly to the peripheral wall 10a of the upstream part 100 of said hollow body 1. A cleaning fluid inlet nozzle 110 and a drying fluid inlet nozzle 111 extend from the upstream end 11 in the opposite direction to the cavity 14.

In the case shown in FIGS. 2 and 3, each of these nozzles has a substantially cylindrical shape and is pierced right through, from upstream to downstream, by an inlet channel for injecting the corresponding fluid: the cleaning fluid inlet nozzle 110 is thus pierced right through, from upstream to downstream, by a cleaning fluid inlet channel 112, and the drying fluid inlet nozzle 111 is pierced right through, from upstream to downstream, by an inlet channel 113 for injecting this drying fluid.

The cleaning fluid inlet channel 112 opens out into the cavity 14 flush with inner wall of the upstream end 11, and as has been stated above, the presence of cleaning fluid in the cavity, arriving through the inlet channel 112, contributes to exerting pressure on the distribution rod housed in this cavity, so as to move it between its extreme positions.

While the cleaning fluid inlet nozzle 110 extends from the upstream end 11 and has a channel opening out into the cavity 14, the drying fluid inlet nozzle 111 continues, within the cavity 14 of the hollow body 1, into a conveying tube 114 that extends coaxially with the drying fluid inlet nozzle 111 and is arranged inside the hollow body in a duct made in the rod 2.

The drying fluid inlet channel 113 extends to the downstream extremity of this conveying tube 114, within the rod 2 into which it opens out. Thus, the cleaning fluid inlet channel 112 and the drying fluid inlet channel 113 open out separately into the cavity 14 or into the rod 2.

A peripheral groove 115 is arranged in the outer wall of the conveying tube 114, in the vicinity of the downstream extremity thereof, to receive a seal 116, for example an O-ring the role of which will be stated below.

A finger 117, advantageously substantially cylindrical, also extends from the inner surface of the upstream end 11, parallel, or substantially parallel, to the conveying tube 114. The finger 117 is arranged substantially between the conveying tube 114 and the through-orifice of the cleaning fluid inlet channel 112. Advantageously, the axis of rotation of the finger 117 is substantially parallel to the axis of the drying fluid inlet channel 113 and the axis of the cleaning fluid inlet channel 112. In accordance with the layout of the conveying tube 114, the finger 117 is arranged such that it is housed in a duct made in the rod.

In other words, and particularly as shown in FIGS. 2 and 3, the conveying tube 114, the cleaning fluid inlet channel 112 and the drying fluid inlet channel 113, and the finger 117 are all parallel to each other, the conveying tube 114 continuing the drying fluid inlet channel 113 while the finger is offset relative to the cleaning fluid inlet channel 112.

A peripheral groove 118 is arranged in the outer wall of the finger 117, in the vicinity of the downstream extremity thereof, to receive a seal 119, for example an O-ring, the role of which will be stated below.

In the embodiment shown, the length of the finger 117, i.e. the distance over which it extends from the upstream end 11, is slightly greater than the length of the tube 114. In particular, the downstream extremity part of the finger 117, which extends beyond the downstream extremity part of the tube 114, is slightly narrowed at the downstream extremity thereof. In other words, the finger 117 includes, at the downstream extremity thereof, a terminal appendage 1170 with a smaller diameter.

According to the invention, the downstream end 12 of the hollow body 1 is pierced by an orifice 120 the walls of which are continued both upstream, within the cavity 14 of the hollow body, and downstream, outside the hollow body 1, by a sleeve 121, the outer diameter of which is defined in relation to the spring 3 so that the spring can be inserted around said sleeve in the cavity 14. Details of the other shapes and dimensions of the sleeve 121 will be given below.

The cleaning and drying fluid distribution rod 2 will now be described in more detail.

In the example more particularly shown in FIGS. 2 and 3, the distribution rod 2 has a substantially cylindrical shape, and the outer diameter thereof is slightly smaller than the inner diameter of the sleeve 121 of the downstream part 101 of the hollow body 1, such that it can slide freely within said sleeve while remaining axially aligned therewith. According to the invention, the distribution rod 2 includes, in the vicinity of the upstream extremity thereof, a rim 20 protruding from the perimeter of the distribution rod 2.

The distribution rod 2 is pierced, from upstream to downstream, by two separate channels, namely a cleaning fluid distribution channel 21 and a drying fluid distribution channel 22. The cleaning fluid distribution channel 21 and the drying fluid distribution channel 22 each open out, at the downstream extremity of the distribution rod 2, into one or more separate distribution orifices, not shown in the figures. In other words, a first channel in the rod is specifically dedicated to the circulation of the cleaning fluid, and the fluid sprayed for the cleaning of the optical sensor exits one or more distribution orifices made on this first channel, while a second channel, arranged next to the first channel in the rod and separate therefrom, is specifically dedicated to the circulation of the drying fluid, and the fluid sprayed for the drying of the sensor exits one or more distribution orifices made specifically on this second channel.

Advantageously, the cleaning fluid distribution channel 21 and the drying fluid distribution channel 22 are parallel and arranged, in the distribution rod 2, with spacing that is substantially identical to the spacing between the conveying tube 114 and the finger 117 in the hollow body 1. In other words, the hollow body and the rod of the device according to the invention are respectively configured so that the conveying tube 114 and the finger 117 can simultaneously be engaged in the drying fluid distribution channel 22 and in the cleaning fluid distribution channel 21 respectively.

In this way, two separate cleaning and drying fluid conveying units are formed. A drying fluid conveying unit consists of the alignment of the inlet nozzle 111 and the conveying tube 114, pierced right through by the inlet channel 113, and of the distribution channel 22 made specifically in the rod 2 and into which the conveying tube 14 opens out. The drying fluid passes directly from the inlet nozzle 111 to the distribution orifices made in the drying fluid distribution channel, without being in contact with the cleaning fluid and without contact with the outside of the rod 2. In addition, the cleaning fluid conveying unit consists of a succession of unaligned elements, namely the inlet nozzle 110 out of alignment with the distribution channel 21 made specifically in the rod 2 and in which the finger associated with the cleaning fluid inlet nozzle is housed. The cleaning fluid passes from the inlet nozzle 111 to the distribution orifices made in the cleaning fluid distribution channel, first passing into a chamber 14 in which it is in contact with the outside of the rod 2. In this, the cleaning fluid conveying unit forms part of the means of moving the inlet rod since the cleaning fluid injected into the chamber 14, pending the passage thereof into the rod and the distribution thereof via the distribution orifices, presses on the rod against the elastic return force exerted by the spring. The movement means thus consist of the cleaning fluid and the means of pressurized filling of the chamber with this cleaning fluid, and the spring forming the elastic return element.

From the upstream extremity of the distribution rod 2 to the downstream extremity thereof, the cleaning fluid distribution channel 21 has, in the device according to the invention, at least one upstream portion, with a larger diameter, one intermediate portion, the diameter of which is slightly smaller than the diameter of the upstream portion, and a downstream portion, the diameter of which is smaller than both the diameter of the intermediate portion and the diameter of the upstream portion. More specifically, the cleaning fluid distribution channel 21 forms, at the intersection between the upstream portion thereof and the intermediate portion thereof, a first shoulder 210, and it forms, at the intersection between the intermediate portion thereof and the downstream portion thereof, a second shoulder 211. It must be noted that although the difference between the diameter of the upstream portion and the diameter of the intermediate portion of the distribution channel 21 is relatively small, the difference between the diameter of the intermediate portion and the diameter of the downstream portion of this same distribution channel 21 is significantly larger, such that the downstream portion of this cleaning fluid distribution channel constitutes a bottleneck zone thereof.

The diameter of the intermediate portion of the cleaning fluid distribution channel 21 is very slightly larger than the outer diameter of the finger 117. More specifically, according to the invention, the diameter of the intermediate portion of the cleaning fluid distribution channel 21, the outer diameter of the finger 117 of the hollow body 1, and the dimensions of the O-ring 119 arranged in the vicinity of the downstream extremity of this finger 117 are defined so that said finger 117 can slide in a sealed manner within the intermediate portion of the cleaning fluid distribution channel 21.

It will be understood that as a result of the above, a space 212 is formed between the wall defining the upstream portion of the cleaning fluid distribution channel 21 and the finger 117, so that cleaning fluid can circulate freely in this space between the cavity 14 and the first shoulder 210.

The drying fluid distribution channel 22 differs from the cleaning fluid distribution channel 21, particularly in the absence of a space formed around the conveying tube 14 sufficient to allow cleaning fluid coming from the cavity 14 to flow along this drying fluid distribution channel. From the upstream extremity of the distribution rod 2 to the downstream extremity thereof, the drying fluid distribution channel 22 has, in the device according to the invention, at least one upstream portion and one downstream portion the diameter of which is smaller than the diameter of the upstream portion. More specifically, the drying fluid distribution channel 22 forms, at the intersection between the upstream portion and the downstream portion thereof, a shoulder 220. It must be noted that the difference between the diameter of the upstream portion and the diameter of the downstream portion of this same distribution channel is relatively large, and that the downstream portion of this drying fluid distribution channel constitutes a bottleneck zone thereof.

The diameter of the drying fluid distribution channel 22, in the upstream portion thereof, is very slightly larger than the outer diameter of the conveying tube 114 that continues the inlet nozzle 111 for injecting said drying fluid. More specifically, according to the invention, the diameter of the upstream portion of the drying fluid distribution channel 22, the outer diameter of the conveying tube 114, and the dimensions of the O-ring 116 arranged in the vicinity of the downstream extremity of this conveying tube 114 are defined so that the conveying tube can slide in a sealed manner within the upstream portion of the drying fluid distribution channel 22, so that as stated above, no space is formed.

According to the invention, the rim 20 of the distribution rod 2, located in the vicinity of the upstream extremity thereof, has an outer diameter that is slightly smaller than the inner diameter of the locking ring 13 of the hollow body 1, i.e., in other words, than the diameter of the cavity 14 of this same hollow body 1.

A peripheral groove 200 is arranged in the outer wall of the rim 20, to receive a seal 201 and, according to the invention, the outer diameter of the rim 20 of the distribution rod 2 and the seal 201 are defined so that the distribution rod 2, provided with its seal 201, can slide in a sealed manner within the cavity 14 of the hollow body 1. As shown, the seal 201 is a lip seal.

The assembly of the device according to the invention can then take place as follows.

Firstly, the downstream end 23 and the sleeve 13 are assembled, by compressing the associated O-ring 15b between the two parts. The spring 3 is then placed around the sleeve 121 of the downstream end 12, pressing against the inner surface of said downstream end 12.

The distribution rod 2, provided with its seal 201 housed in the rim 20, is then inserted into the sleeve 121 of the downstream part 101 of the hollow body 1, in which it is, due to the outer diameter thereof and the inner diameter of said sleeve, fitted to slide freely while remaining axially aligned therewith, the seal 201 then being compressed against the inner wall of the locking ring, such that the distribution rod can slide freely but in a sealed manner within the locking ring. The flange 20 has a bearing face for the spring 3 and the free end thereof opposite the upstream end wall, and the spring 3 thus contributes to the positioning of the rod 2 in relation to the hollow body 1.

The upstream part 100 of the hollow body 1 is then fitted onto the first sleeve 131 of the locking ring, pressing on the O-ring 15a placed in the upstream end 11. In this operation, and due to the respective dimensions of these different elements, the finger 117 and the conveying tube 114 are simultaneously engaged respectively in the cleaning fluid distribution channel and in the drying fluid distribution channel 22 arranged in the distribution rod 2.

The unit constituted in this way forms the inlet and distribution device of the device according to the invention.

As a result of the above, the relative positions of the distribution rod 2 and the hollow body 1 are, within the cavity 14 of this same hollow body 1, defined by the equilibrium that is established between the return force of the spring 3 and the force that can be exerted on the upstream surface of the rim 20 of the distribution rod 2. In other words, the relative positions of the finger 117 and the conveying tube 114 within the cleaning fluid distribution channel 21 and the drying fluid distribution channel 22 respectively are also governed by the equilibrium that will be established between the return force of the spring 3 and a force that will be exerted on the rim 20 of the distribution rod 2. Depending on the intensity of the force that will be applied to the upstream surface of the rim 20 of the distribution rod 2, the distribution rod will or will not slide downstream through the sleeve 121 of the downstream part 101 of the hollow body 1, compressing or not compressing the spring 3. In the absence of any force applied to the upstream surface of the rim 20 of the distribution rod 2, the distribution rod will thus be in a first extreme position, or idle position, in which the spring 3 will be completely relaxed. Conversely, when the spring 3 is as compressed as possible, the distribution rod 2 will have reached a second extreme position, or cleaning position, in which it has slid as far downstream as possible, through the sleeve 121 of the downstream part of the hollow body 1.

FIG. 2 shows the device according to the invention in the idle position thereof as described above, in which only the return force of the spring 3 is exerted on the distribution rod 2, keeping it in the vicinity of the upstream part of the hollow body 1, so that this spring 3 is completely relaxed. This position corresponds to a situation in which no cleaning fluid and no drying fluid is injected into the inlet and distribution head described above. In this relative position of the distribution rod 2 and the hollow body 1, the finger 117 is engaged in the cleaning fluid distribution channel 21 such that the O-ring 119 arranged in the vicinity of the downstream end thereof is located in the intermediate portion of said cleaning fluid distribution channel, which is thus closed in a sealed manner. Any fluid that might be present in the cleaning fluid inlet nozzle 110 cannot therefore, in this idle position, circulate to the downstream portion of the cleaning fluid distribution channel 21. It must be noted that, as shown in FIG. 2, this sealing between the cleaning fluid inlet nozzle 110 and the downstream portion of the distribution channel 21 for distributing this same fluid is supplemented by the sealing resulting from the upstream extremity of the distribution rod 2 pressing against the inner surface of the upstream end 11. It must also be noted that, as shown in FIG. 2, the inner wall of the upstream end 11, the upstream extremity of the distribution rod 2, the upstream surface of the rim 20 of this same distribution rod, and the inner wall of the first sleeve 131 of the locking ring together define an inlet chamber 4. This inlet chamber 4 is sealed due to the presence of the seal 201 placed on the periphery of the rim 20 of the distribution rod and due to the presence of the seal 15a against which the first sleeve 131 of the locking ring presses. In the idle position shown in FIG. 2, and as disclosed above, this inlet chamber 4 is also, through the position of the finger 117 within the intermediate portion of the cleaning fluid distribution channel 21, sealed vis-à-vis the downstream portion of the distribution channel. In the idle position shown in FIG. 2, a fluid present in the drying fluid inlet nozzle 111 can, conversely, circulate freely to the downstream extremity of the drying fluid distribution channel 22.

FIG. 3 shows the device according to the invention in the cleaning position defined above. When a fluid is injected, in the direction shown by the arrow A, through the cleaning fluid inlet nozzle 110, it enters the aforementioned inlet chamber 4, in which it exerts, on the upstream surface of the rim 20 of the distribution rod, a force that causes this distribution rod to slide downstream within the hollow body 1 away from the upstream wall and compressing the spring 3, thus increasing the volume of the inlet chamber 4. The sliding downstream of the distribution rod 2 relative to the hollow body 1 causes a relative sliding of the finger 117 towards the upstream portion of the cleaning fluid distribution channel 21 within the distribution rod. It must be understood here that only the distribution rod moves, and it is only the relative positions between the different components thereof and the different components of the hollow body 1 that change.

The dimensions of the different components of the device according to the invention are defined such that, in the relative sliding of the finger 117 towards the upstream portion of the cleaning fluid distribution channel 21, the O-ring 119 placed at the downstream extremity of this finger 117 passes over, in an upstream direction, the first shoulder 210 defined by the intersection of the upstream portion and the intermediate portion of the cleaning fluid distribution channel 21, and is thus located within said upstream portion of said distribution channel. Since the diameter of this upstream portion is slightly larger than the diameter of the intermediate portion of this distribution channel, the sliding of the finger 117 within the distribution channel is then no longer sealed. The cleaning fluid can therefore flow to the downstream portion of this distribution channel 21 and thus to the corresponding distribution orifices and to the surface of the optical sensor to be cleaned. It must be noted here that the presence of the appendage 1170, which has a smaller diameter, at the extremity of the finger 117, enables improved circulation of the cleaning fluid by preventing any “suction” effect that could occur at the moment when the O-ring 119 passes over the first shoulder 210. The relative sliding of the finger 117 in the upstream portion of the cleaning fluid distribution channel 21 continues until the injection of fluid through the nozzle 110 ceases, or until the downstream surface of the rim 20 of the distribution rod is pressing against the upstream extremity of the sleeve 121 of the hollow body 1, as shown in FIG. 3. In this cleaning position, the distribution rod 2 is in an extreme position extended downstream of the hollow body 1, which corresponds to a position in which the cleaning fluid and drying fluid distribution orifices respectively, located at the downstream extremity thereof, are as close as possible to the surface of the optical sensor to be cleaned.

When the injection of cleaning fluid ceases, the return force of the spring 3 causes the spring to relax until it returns to its initial position, pushing on the downstream surface of the rim 20, in the opposite direction to the sleeve 121. In this movement, the distribution rod 2 then slides, this time, in the upstream direction of the device according to the invention, and the volume of the inlet chamber 4 decreases, the inlet chamber emptying in particular through the cleaning fluid distribution channel 21. This continues until the O-ring 119 placed at the downstream extremity of the finger 117 passes over, in a downstream direction this time, the first shoulder 210 defined by the intersection of the upstream portion and the intermediate portion of the cleaning fluid distribution channel 21 and this O-ring 119 is located in said intermediate portion of said distribution channel. The sliding of the finger 117 relative to the cleaning fluid distribution channel 21 then becomes sealed again, and the cleaning fluid can no longer flow to the downstream portion of this same distribution channel or to the corresponding distribution orifices.

It must be noted that, during these different operations, the conveying tube 114 which continues, within the cavity 14 of the hollow body 1, the drying fluid inlet nozzle 11, moves, in the same way as the finger 117, relative to the distribution rod and, in particular, relative to the drying fluid distribution channel 22. Thus, when a quantity of cleaning fluid is injected into the inlet chamber 4, the conveying tube 114 slides within the distribution channel 22, towards the upstream portion thereof, and when this injection ceases, it slides, within this same drying fluid distribution channel 22, towards the downstream portion thereof. Advantageously, the respective dimensions of the conveying tube 114 and the distribution rod 2 are defined such that the relative sliding of this conveying tube within said drying fluid distribution channel 22 remains sealed regardless of the relative positions of these two elements. It must also be noted that, as shown in FIGS. 2 and 3, a fluid injected through the drying fluid inlet nozzle 111 can, regardless of the relative positions of the distribution rod 2 and the hollow body 1, flow freely to the downstream portion of the drying fluid distribution channel 22 and thus to the corresponding distribution orifices and the surface of the optical sensor in question.

The hydraulic architecture of the cleaning device according to the invention will now be described, with particular reference to FIG. 4. The hydraulic architecture of the device according to the invention includes a cleaning fluid storage tank 5, and a pump 6 for circulating this fluid. The pumped cleaning fluid is sent through a first pipe 60, on which is mounted a distributor 8 that will be described below and which forms all or part of elements for governing the circulation of the cleaning fluid between the tank and the fluid inlet and distribution device D.

The hydraulic architecture also comprises a tank 7 for storing a drying fluid or obtaining a stream of such a fluid, provided if applicable with a compressor that makes it possible to obtain a stream of compressed air suitable for drying an optical sensor of an optical detection system of a motor vehicle, a second pipe 70 being arranged to deliver drying fluid from the storage tank inside the cleaning device.

The distributor 8 makes it possible to alternately control the injection of cleaning fluid into the cleaning fluid inlet nozzle 110 and the injection of drying fluid into the drying fluid inlet nozzle 111. To do this, the distributor 8 is governed to adopt at least three different positions, each of which corresponds to an operational state of the device according to the invention: an idle position, with the first pipe 60 connected to the distributor on the first position P1 and in which no cleaning fluid passes through the distributor, in either direction, an outward, or filling position, with the first pipe 60 connected to the distributor on a second position P2 (as shown in FIG. 4) and in which the cleaning fluid can only circulate in the outward direction from the storage tank to the inlet and distribution device, and a return, or emptying position, with the first pipe 60 connected to the distributor on a third position P3 and in which the cleaning fluid can only circulate in the direction going from the inlet and distribution device to the storage tank.

This distributor is governed by a control module, not shown here, configured to control the change of state of the distributor and forming therewith the elements for governing the circulation of at least the cleaning fluid between the storage tank and the fluid inlet and distribution device.

These governing elements are configured to block the injection of cleaning fluid into the inlet and distribution device in an idle position, to supply the inlet and distribution device with cleaning fluid in order firstly to move the inlet and distribution device into a cleaning position and secondly to spray cleaning fluid, and to block the cleaning fluid in the cavity and keep the inlet and distribution device in the cleaning position, the supply of drying fluid being capable of being governed independently of the supply of cleaning fluid.

In the idle position, the means that control the delivery of the cleaning fluid are closed, and no fluid is injected into the inlet and distribution device according to the invention. Simultaneously, the injection of the drying fluid is blocked by a suitable valve not shown here.

In the outward position, the distributor 8 permits the injection of a first quantity of cleaning fluid towards the inlet and distribution device, sufficient to push on the rim of the rod and force the extension of the rod outside the hollow body. Simultaneously, the means that control the delivery of the drying fluid are closed. More specifically, in this state, the first quantity of cleaning fluid injected into the inlet chamber 4 by means of the distributor 8 is defined by the aforementioned control means so that the relative movement of the finger 117 in relation to the cleaning fluid distribution channel 21 causes the O-ring 119 placed in the vicinity of the downstream extremity of the finger 117 to pass over the shoulder 210 and be located in the upstream portion of this distribution channel, thus permitting the flow of the cleaning fluid to the downstream portion and to the corresponding distribution orifices and to the surface of the optical sensor to be cleaned. In this state, the distribution rod 2 is in its extreme position extended downstream. The distributor 8 remains in this filling position of the inlet and distribution device until cleaning fluid is sprayed via the cleaning fluid distribution channel 21.

When the drying of the optical sensor is required, the distributor 8 is governed so that it returns to an idle position, in order to stop the arrival of cleaning fluid and especially to block the return of the fluid present at this moment in the chamber 4. It will be understood that it is necessary according to the invention that the distribution rod 2 remains in the extended cleaning position with the distribution orifices arranged in the vicinity of the optical sensor to be cleaned, so that the drying fluid is sprayed as close as possible to the optical sensor. The cleaning fluid is blocked and it cannot be ejected from the inlet chamber despite the return force of the spring. Only an infinitesimal portion of fluid is ejected by the cleaning fluid distribution channel 21 before the finger slides under the effect of the spring until the O-ring arranged around the finger 117 adopts a position in the intermediate portion of the cleaning fluid distribution channel 21.

In this idle position, the valve permitting or blocking the passage of drying fluid to the inlet and distribution device is then governed. The drying fluid is sprayed onto the optical sensor, passing through a separate distribution channel from the distribution channel in which the cleaning fluid circulates. When the sufficient quantity of drying fluid has been sprayed, the arrival of drying fluid is blocked and the distributor 8 is governed to the emptying position to discharge the cleaning fluid present in the chamber 4. This results in the retraction of the distribution rod inside the hollow body 1. It can be noted that the circulation of drying fluid is independent of the circulation of cleaning fluid, so that the supply of drying fluid can take place simultaneously or following the supply of cleaning fluid without the drying fluid sprayed being moistened by the presence of residual cleaning fluid.

The invention thus makes it possible, through the simple use of governing means of the distributor type and the novel configuration of the inlet and distribution device described above, to produce a cleaning device that is intended for spraying at least one fluid onto a surface to be cleaned of a motor vehicle, such as an optical sensor of an optical detection system, that is easy to govern and that eliminates any risk of mixing of the cleaning and drying fluids during a cleaning operation, and particularly the risk of spraying a drying fluid moistened before the injection thereof by residual cleaning fluid. The invention thus makes it possible to improve the effectiveness and quality of such cleaning and to improve the quality of the signal supplied by this sensor and the driving assistance associated therewith.

The invention is not however limited to the means and configurations described and shown, and also applies to all equivalent means and configurations and any combination of such means. In particular, although the invention has been described here in an embodiment in which the general geometry of the inlet and distribution device and the components thereof is a cylindrical geometry, the invention obviously applies to all types of geometry and shape, provided that the elements producing the different seals and functions described herein are present.

1. A cleaning device for spraying at least one fluid onto a surface to be cleaned of an optical sensor of an optical detection system of a motor vehicle, the cleaning device comprising:
at least one fluid inlet and distribution device into which a cleaning fluid and a drying fluid are selectively injected from an inlet nozzle specific to each fluid,
wherein the inlet and distribution device includes separate distribution channels for distributing the cleaning fluid and the drying fluid respectively, and separate conveying units for conveying each of the fluids from the respective inlet nozzle thereof to the respective distribution channel thereof.

2. The cleaning device as claimed in claim 1, wherein the separate distribution channels for distributing the cleaning fluid and the drying fluid respectively include distribution orifices specific to each channel.

3. The cleaning device as claimed in claim 1, wherein the separate distribution channels are made in an inlet and distribution rod arranged in a hollow body of the inlet and distribution device.

4. The cleaning device as claimed in claim 3, wherein a first inlet nozzle opens out into a cavity formed in the hollow body and in which the rod is housed, a second inlet nozzle opening out directly into a conveying tube housed in a corresponding inlet channel formed in the rod.

5. The cleaning device as claimed in claim 3, further comprising means for moving the inlet and distribution rod between an idle position and an extended position inside the hollow body.

6. The cleaning device as claimed in claim 5, wherein said means for moving the inlet and distribution rod comprise means shared with a conveying unit for conveying one of the fluids.

7. The cleaning device as claimed in claim 5, wherein the means for moving the inlet and distribution rod comprise an element for the elastic return to position of the rod.

8. The cleaning device as claimed in claim 5, wherein the drying fluid distribution channel has a substantially constant diameter at least in the portion in which the conveying tube is caused to move, and in that a peripheral groove is arranged in the outer wall of the conveying tube to receive a seal configured to rub against the drying fluid distribution channel in which the conveying tube is housed.

9. The cleaning device as claimed in claim 3, wherein a finger extends inside the cleaning fluid distribution channel, the finger being offset relative to the axis of elongation of the cleaning fluid inlet nozzle.

10. The cleaning device as claimed in claim 9, wherein the cleaning fluid distribution channel has portions with different diameters, these diameters decreasing from an upstream extremity of the distribution rod to the downstream extremity thereof, at least the downstream extremity of the finger being configured to extend in portions with different diameters depending on the relative movement of the finger in relation to the rod.

11. The cleaning device as claimed in claim 10, wherein the diameter of the intermediate portion of the cleaning fluid distribution channel, the outer diameter of the finger of the hollow body are defined so that said finger can slide in a sealed manner within the intermediate portion of the cleaning fluid distribution channel and let the cleaning fluid through when the seal is within the upstream extremity portion.

12. The cleaning device as claimed in claim 10, wherein the distribution rod comprises, in the vicinity of the upstream extremity thereof, a rim.

13. The cleaning device as claimed in claim 12, wherein a peripheral groove is arranged in the outer wall of the rim, to receive a seal, such that the distribution rod, provided with said seal, can slides in a sealed manner within the hollow body.

14. The cleaning device as claimed in claim 1, further comprising:
a cleaning fluid storage tank;
a drying fluid storage tank; and
elements for governing the circulation of cleaning fluid between the tank and the inlet and distribution device, configured to:
block the injection of cleaning fluid into the inlet and distribution device in an idle position,
supply the inlet and distribution device with cleaning fluid in order firstly to move this inlet and distribution device into a cleaning position and secondly to spray cleaning fluid, and
block the cleaning fluid in the cavity and keep the fluid inlet and distribution device in the cleaning position, the supply of drying fluid being capable of being governed independently of the supply of cleaning fluid.

15. A motor vehicle provided with an optical detection system, comprising at least one cleaning device as claimed in claim 1 for cleaning an optical sensor of this optical detection system.
